(19) United States
(12) Patent Application Publication
(10) Pub. No.: US 2026/0351164 A1
(43) Pub. Date: Nov. 5, 2026

(54) ELECTRONIC DEVICE FOR IMPLEMENTING DRIVING SIGNALS BASED ON TEMPERATURE DATA

(71) Applicant: Samsung Display Co., Ltd., Yongin-si (KR)

(72) Inventors: Jun-Young KO, Yongin-si (KR); Heewoong Park, Yongin-si (KR); Junghun Sin, Yongin-si (KR); Kuk-Hwan Ahn, Yongin-si (KR); Hansu Cho, Yongin-si (KR)

(73) Assignee: Samsung Display Co., Ltd., Yongin-si (KR)

(21) Appl. No.: 19/558,064

(22) Filed: Mar. 5, 2026

(30) Foreign Application Priority Data
May 2, 2025 (KR) 10-2025-0058070

(51) Int. Cl. G09G 3/32

(52) U.S. Cl. CPC G09G 3/32; G09G 2310/0267; G09G 2310/0275; G09G 2320/041; G09G 2330/021

(57) ABSTRACT

An electronic device including a display panel. The electronic device including a display panel driver configured to drive the display panel based on input image data and an input control signal. The electronic device including one or more sensors configured to output sensing data by sensing a temperature of the display panel. The electronic device including a sensor driver configured to output temperature data to the display panel driver based on the sensing data. The electronic device including a device controller configured to control the display panel driver and the sensor driver. The device controller is configured to output the input image data to the display panel driver. The display panel driver is configured to output a driving signal to the display panel based on the temperature data, the input image data, and input control signal.

### CROSS-REFERENCE TO RELATED APPLICATIONS

This application claims priority under 35 USC § 119 to Korean Patent Application No. 10-2025-0058070, filed on May 2, 2025, the content of which is herein incorporated by reference in its entirety.

### BACKGROUND

### 1. Field

The disclosure relates to an electronic device implementing driving signals based on temperature data. More particularly, the disclosure relate to an electronic device in which a display quality is improved by modifying driving signals based on temperature data.

### 2. Description of Related Art

Generally, a display device includes a display panel and a display panel driver. The display panel includes a plurality of gate lines, a plurality of data lines, a plurality of emission lines, and a plurality of pixels. The display panel driver includes a gate driver providing a gate signal to the gate lines, a data driver providing a data voltage to the data lines, an emission driver providing an emission signal to the emission lines, and a driving controller controlling the gate driver, the data driver and the emission driver.

An electronic device may include an ultrasonic fingerprint sensor to sense a user’s fingerprint. The ultrasonic fingerprint sensor may measure a frequency at which ultrasonic waves emitted from the user’s body return.

A sensing operation of an ultrasonic fingerprint sensor is sensitive to temperature, so the ultrasonic fingerprint sensor may include a temperature sensor.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

Embodiments of the present disclosure provide an electronic device for improving display quality .

According to embodiments, an electronic device including a display panel. The electronic device including a display panel driver configured to drive the display panel based on input image data and an input control signal. The electronic device including one or more sensors configured to output sensing data by sensing a temperature of the display panel. The electronic device including a sensor driver configured to output temperature data to the display panel driver based on the sensing data. The electronic device including a device controller configured to control the display panel driver and the sensor driver. The device controller is configured to output the input image data to the display panel driver. The display panel driver is configured to output a driving signal to the display panel based on the temperature data, the input image data, and the input control signal.

In an embodiment, the one or more sensors are configured to: transmit an ultrasonic wave towards a body of a user; and output the sensing data by receiving at least a portion of the ultrasonic wave reflected by the body. The sensor driver is configured to generate ultrasonic wave data based on the sensing data. The sensor driver is configured to output the temperature data and the ultrasonic wave data to the device controller.

In an embodiment, the temperature data is based on a variance of the temperature of the display panel.

In an embodiment, the temperature data is based on an absolute value of the temperature of the display panel.

In an embodiment, the temperature data is based on a difference value between the temperature of the display panel and a reference temperature.

In an embodiment, the sensor driver is configured to output the temperature data to the display panel driver in real time.

In an embodiment, the sensor driver is configured to output the temperature data to the display panel driver based on a frame period in which the display panel is driven changing from a first frame to a second frame.

In an embodiment, the sensor driver is configured to output the temperature data to the display panel driver as a result of the display panel displaying a reference pattern.

In an embodiment, the sensor driver is configured to output the temperature data to the display panel driver as a result of an image displayed on the display panel changing from a first display pattern to a second display pattern.

In an embodiment, the sensor driver and the display panel driver are connected through a connection line. The temperature data is serial data.

In an embodiment, the temperature data is a variance of the temperature of the display panel.

In an embodiment, the sensor driver and the display panel driver are connected through three connection lines. The temperature data is parallel data.

In an embodiment, the temperature data is an absolute value of the temperature of the display panel.

In an embodiment, the display panel driver includes: a gate driver configured to output a gate signal to the display panel; an emission driver configured to output an emission signal to the display panel; a data driver configured to apply a data voltage to the display panel; and a driving controller configured to control the gate driver, the emission driver, and the data driver based on the input image data, the input control signal, and the temperature data.

In an embodiment, the driving controller is configured to output a data signal to the data driver based on the input image data and the temperature data. The data driver is configured to output the data voltage based on the data signal. The display panel is configured to display an image based on the data voltage.

In an embodiment, the driving controller is configured to output a data signal to the data driver based on the input image data. The driving controller is configured to output a data control signal to the data driver based on the temperature data. The data driver changes a range of the data voltage based on the data control signal.

In an embodiment, the display panel includes a display region which displays an image. The gate driver is on a first peripheral region space apart from the display region in a first direction. The one or more sensors are on the first peripheral region.

According to embodiments, an electronic device includes a display panel configured to display an image. The electronic device includes a display panel driver configured to drive the display panel based on input image data and an input control signal. The electronic device includes one or more sensors configured to sense a temperature of the display panel, and output sensing data by sensing a reflected ultrasonic wave. The electronic device includes a sensor driver configured to control the one or more sensors. The electronic device includes a device controller configured to control the display panel driver and the sensor driver. The device controller is configured to output the input image data to the display panel driver. The sensor driver is configured to output temperature data to the display panel driver based on the sensing data, and output the temperature data and ultrasonic wave data to the device controller.

In an embodiment, the temperature data is a variance of the temperature of the display panel.

In an embodiment, the temperature data is an absolute value of the temperature of the display panel.

According to embodiments, an electronic device including a display panel. The electronic device including a display panel driver configured to drive the display panel based on input image data and an input control signal. The display panel driver includes a gate driver configured to output a gate signal to the display panel, and an emission driver configured to output an emission signal to the display panel. The electronic device including one or more sensors configured to output sensing data by sensing a temperature of the display panel. The electronic device including a sensor driver configured to output temperature data to the display panel driver based on the sensing data. The electronic device including a device controller configured to control the display panel driver and the sensor driver. The display panel driver is configured to output a driving signal to the display panel based on the temperature data. The one or more sensors are in a peripheral region of the display panel. The gate driver and/or the emission driver are in the peripheral region of the display panel

In an embodiment, the sensor driver and the display panel driver are connected through a single connection line.

In an embodiment, the driving controller is configured to output a data signal to the data driver based on the temperature data.

As described above, a sensor driver may output temperature data received from a sensing block to a display panel driver. For example, the sensor driver may directly output the temperature data to the display panel driver. Since the sensing block may include a temperature sensor, an accuracy of the temperature data may be improved. The display panel driver may drive the display panel based on the temperature data with improved accuracy. Accordingly, an influence of temperature on the image displayed by the display panel may be compensated for. Accordingly, a display quality of the display panel may be improved.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to embodiments of the disclosure.

FIG. 2 is a block diagram illustrating a display device according to embodiments of the disclosure.

FIG. 3 is a diagram illustrating a change of an image in which a display panel included in an electronic device of FIG. 1 according to embodiments of the disclosure.

FIG. 4 is a block diagram illustrating an example of an operation of a display panel driver, a sensing block, and a sensor driver included in an electronic device of FIG. 1 according to embodiments of the disclosure.

FIG. 5 is a block diagram illustrating an example of an operation of a display panel driver, a sensing block, and a sensor driver included in an electronic device of FIG. 1 according to embodiments of the disclosure.

FIG. 6 is a block diagram illustrating an example of a display panel and a sensing layer included in an electronic device of FIG. 1 according to embodiments of the disclosure.

FIG. 7 is a block diagram illustrating an example of a location of a display panel and a temperature sensor included in an electronic device of FIG. 1 according to embodiments of the disclosure.

FIG. 8 is a block diagram illustrating an example of a pixel circuit of a display device of FIG. 2 according to embodiments of the disclosure.

FIG. 9 is a block diagram illustrating an example of a driving controller included in a display device of FIG. 2 according to embodiments of the disclosure.

FIG. 10 is a table illustrating an example of a temperature lookup table stored in a signal receiving block included in the driving controller of FIG. 9 according to embodiments of the disclosure.

FIG. 11 is a table illustrating an example of a grayscale lookup table stored in a data outputting block included in the driving controller of FIG. 9 according to embodiments of the disclosure.

FIG. 12 is a block diagram illustrating an example of a gamma reference voltage generator included in a display device of FIG. 2 according to embodiments of the disclosure.

FIG. 13 is a block diagram illustrating an electronic device according to embodiments of the disclosure.

FIGS. 14-16 are schematic diagrams illustrating an electronic device according to embodiments according to embodiments of the disclosure.

### DETAILED DESCRIPTION

All of the embodiments described herein are non-limiting example embodiments, and thus, the disclosure is not limited thereto and may be realized in various other forms.

In the following embodiments, the terms such as “first” and “second” are not used in a limiting sense, but are used for the purpose of distinguishing a component from another.

In the following embodiments, singular expressions include plural expressions unless the context clearly indicates otherwise.

In the following embodiments, terms such as “include” or “have” mean that a feature or component described in the specification is present, and do not exclude in advance the possibility that one or more other features or components may be added.

In the drawings, the sizes of components may be exaggerated or reduced for convenience of explanation. In some embodiments, the size and thickness of each component shown in the drawings are arbitrarily shown for convenience of explanation, and therefore, the disclosure is not necessarily limited to what is shown.

As used herein, the term “and/or” includes any and all combinations of one or more of the associated listed items. For example, an expression, “a and/or b” should be understood as including only a, only b and both a and b. As used herein, the expression “at least one of” preceding a list of elements modifies the entire list of the elements and does not modify the individual elements of the list. For example, expressions “at least one of a, b, and c” and “at least one of a, b, or c” should be understood as including only a, only b, only c, both a and b, both a and c, both b and c, or all of a, b, and c.

Hereinafter, the embodiments of the disclosure will be described in detail with reference to the attached drawings. When describing with reference to the drawings, identical or corresponding components will be given the same drawing reference numerals.

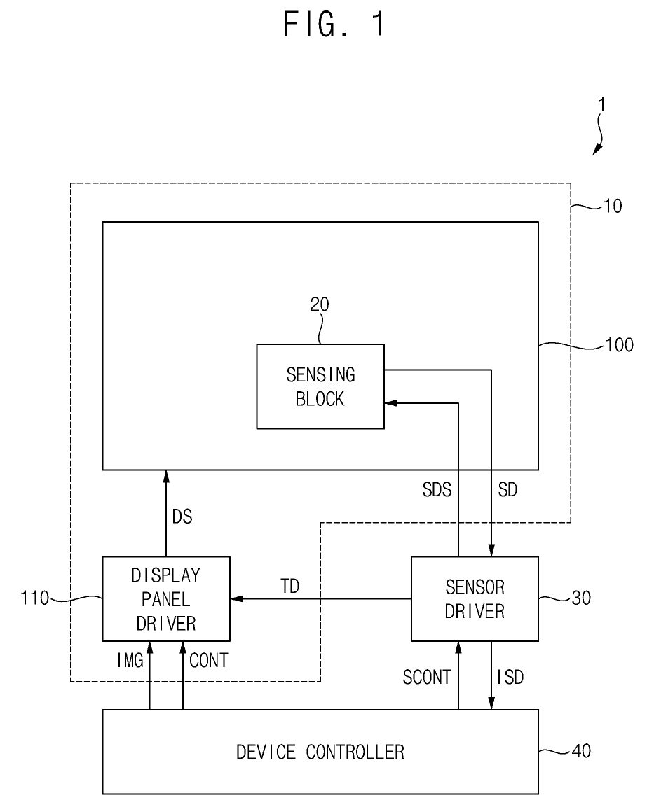

FIG. 1 is a block diagram illustrating an electronic device 1 according to embodiments of the disclosure.

Referring to FIG. 1, an electronic device 1 may include a display device 10, a sensing block 20, a sensor driver 30, and a device controller 40.

The display device 10 may include a display panel 100 and a display panel driver 110.

The display panel 100 may display an image based on a driving signal DS.

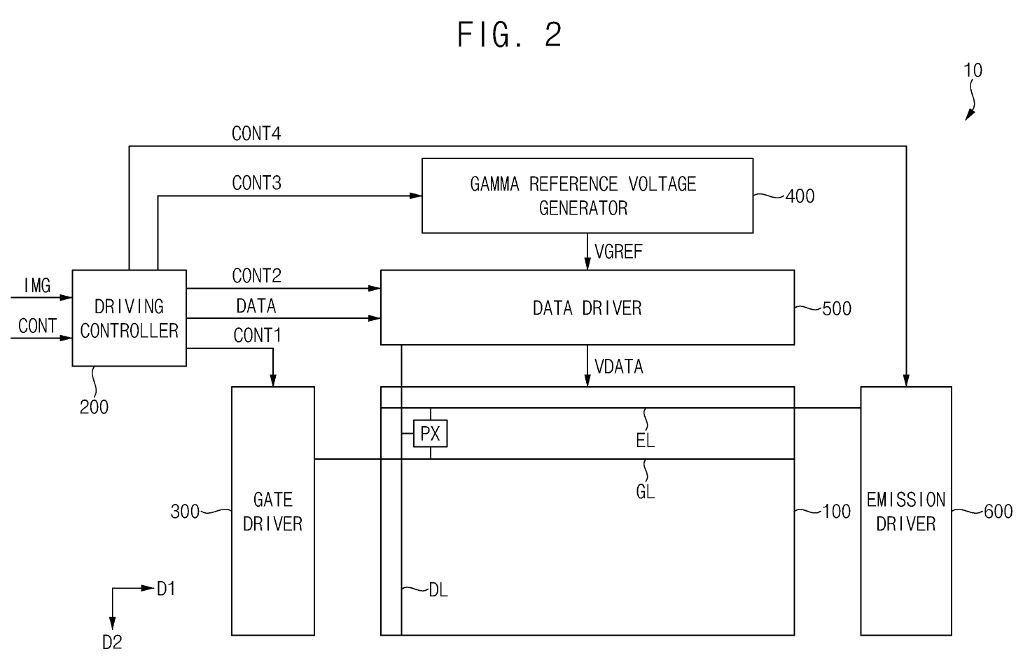

The display panel driver 110 may output the driving signal DS to the display panel 100 based on input image data IMG, an input control signal CONT, and temperature data TD. For example, the driving signal DS may include a data voltage VDATA illustrated in FIG. 2, a gate signal, and an emission signal. The display panel driver 110 may output the driving signal DS based on a temperature of the display panel 100.

The sensing block 20 may perform a sensing operation based on a sensing signal SDS. The sensing block 20 may sense the temperature of the display panel 100 and sense ultrasonic waves. In an embodiment, the sensing block 20 may be disposed on a lower surface of the display panel 100. In an embodiment, the sensing block 20 may include one or more sensors.

The sensing block 20 may transmit ultrasonic waves towards the user’s body (e.g., a finger) and receive at least a portion of the ultrasonic waves reflected from the body. For example, the sensing block 20 may include an ultrasonic fingerprint sensor. The ultrasonic fingerprint sensor may operate by measuring the cycle of ultrasonic waves emitted from, or reflected by, the user’s body.

When the sensing block 20 performs an ultrasonic sensing operation, reflection and/or diffraction of ultrasonic waves may occur based on the physical properties of the display panel 100. The physical properties of the display panel 100 may change based on temperature changes of the display panel 100. The sensing block 20 may include a temperature sensor. Since the sensing block 20 may include a temperature sensor, temperature changes of the display panel 100 may be detected. Accordingly, an accuracy of the ultrasonic sensing operation may be improved by using the detected changes in temperature. For example, the sensor driver 30 may detect the temperature change of the display panel 100 and compensate for the ultrasonic signal. In some embodiments, the temperature sensor may be a temperature sensing diode, a temperature sensing transistor, or the like. However, the present disclosure is not limited to a type of temperature sensor.

The sensing block 20 may output, to the sensor driver 30, sensing data SD including information about the temperature of the display panel 100 and information about the reflected ultrasonic waves . For example, the sensing block 20 may be located on the upper or lower surface of the display panel 100.

The sensor driver 30 may output a sensing signal SDS based on a sensing control signal SCONT. The sensor driver 30 may generate temperature data TD and ultrasonic data based on the sensing data SD. The sensor driver 30 may output the temperature data TD to the display panel driver 110. The sensor driver 30 may output integration data ISD including the temperature data TD and the ultrasonic data to the device controller 40.

In an embodiment, the temperature data TD may be a variance in temperature of the display panel 100. The variance in temperature of the display panel 100 may be a difference in temperature which changes over time. For example, the change in temperature of the display panel 100 may be a difference between a first temperature at a first time point and a second temperature at a second time point. The first temperature may be determined based on the sensing data SD sensed by the sensing block 20 at the first time point. The second temperature may be determined based on the sensing data SD sensed by the sensing block 20 at the second time point. For example, when the temperature of the display panel 100 is about 40° C at the first time point and the temperature of the display panel 100 is about 30° C at the second time point, the variance may be about 10° C. In this way, variance of the temperature of the display panel 100 may be a difference between the temperature of the display panel 100 at the current point in time and the temperature of the display panel 100 at the previous point in time.

In an embodiment, the temperature data TD may be an absolute value of the temperature of the display panel 100. The absolute value of the temperature of the display panel 100 may be the temperature of the display panel 100 at a a time. For example, the absolute value of the temperature of the display panel 100 may be the temperature of the display panel 100 based on the sensing data SD sensed by the sensing block 20 at the current time. For example, when the temperature of the display panel 100 at a time is about 50° C, the absolute value may be about 50° C. For example, when the temperature of the display panel 100 at the current time is about -3° C, the absolute value may be about 3° C.

In an embodiment, the temperature data TD may be a difference value between the temperature of the display panel 100 and a reference temperature. For example, the temperature data TD may be a difference value between the temperature of the display panel 100 at the current time and a set reference temperature. The reference temperature may be a temperature set by a setter. For example, when the reference temperature is about 40° C and the temperature of the display panel 100 at the current time is about 20° C, the difference value may be about 20° C. However, the present disclosure is not limited to a value of the reference temperature.

In an embodiment, a determination range of temperature data TD may be set. The determination range of temperature data TD may be set by a setter.

For example, the temperature data TD may be determined in units of about 1° C. For example, when the temperature of the display panel 100 is about 27.5° C, the temperature data TD may be data corresponding to about 27° C. For example, when the temperature of the display panel 100 is about 42.1° C, the temperature data TD may be data corresponding to about 42° C.

For example, the temperature data TD may be determined in units of about 5° C. For example, when the temperature of the display panel 100 is about 27.5° C, the temperature data TD may be data corresponding to about 25° C. For example, when the temperature of the display panel 100 is about 32.1° C, the temperature data TD may be data corresponding to about 30° C. However, the present disclosure is not limited to the determination range of the temperature data TD.

In an embodiment, the temperature data TD may be received by the display panel driver 110 in real time. For example, when the temperature data TD is received by the display panel driver 110 in real time, the temperature data TD may be received at intervals set by a user. As another example, when the temperature data TD is received by the display panel driver 110 in real time, the temperature data TD may be received by the display panel driver 110 at intervals including one or more seconds.

In an embodiment, the temperature data TD may be received by the display panel driver 110 for each frame. For example, when the frame period in which the display panel 100 is driven changes from the first frame to the second frame, the temperature data TD may be received by the driving controller 200. As another example, the timing at which the temperature data TD is received may be synchronized with a vertical synchronization signal.

The device controller 40 may output the input control signal CONT and the input image data IMG to the display panel driver 110. The device controller 40 may output the sensing control signal SCONT to the sensor driver 30.

In the present embodiment, the sensor driver 30 may output the temperature data TD to the display panel driver 110. For example, the sensor driver 30 may directly output the temperature data TD to the display panel driver 110. Since the sensing block 20 may include a temperature sensor, the accuracy of the temperature data TD may be improved. The display panel driver 110 may drive the display panel 100 based on the temperature data TD with improved accuracy. Accordingly, the display device 1 may compensate for the temperature of the display panel 100. Accordingly, a display quality of the display panel 100 may be improved.

Additionally, in some embodiments, the display device 10 may not include a sensing driver for sensing a current change of a pixel circuit PX illustrated in FIG. 2 included in the display panel 100. Accordingly, an integration of the display device 10 may be improved. For example, a bezel size of the display device 10 may be reduced.

Additionally, the sensing block 20 may perform the ultrasonic sensing operation and the sensing block 20 may sense the user’s fingerprint. Accordingly, the electronic device 1 may sense the user’s fingerprint and display an image compensated for temperature.

FIG. 2 is a block diagram illustrating a display device 1 according to embodiments of the disclosure.

Referring to FIGS. 1 and 2, an embodiment of the display device 10 may include a display panel 100 and a display panel driver 110. The display panel driver 110 may include a driving controller 200, a gate driver 300, a gamma reference voltage generator 400, a data driver 500, and an emission driver 600.

The display panel 100 may include a display region on which an image is displayed and a peripheral region adjacent to the display region.

The display panel 100 may include a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1, and the data lines DL may extend in a second direction D2 crossing the first direction D1.

The driving controller 200 may receive input image data IMG and an input control signal CONT from the device controller 40. In an embodiment, for example, the input image data IMG may include red image data, green image data, and blue image data. In some embodiments, the input image data IMG may include white image data. In some embodiments, the input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200 or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In an embodiment, the data driver 500 may be disposed in the peripheral region. In an embodiment, the data driver 500 may be integrated in the peripheral region.

The emission driver 600 may generate emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 2 for convenience of illustration and description, the embodiment disclosed herein are not limited thereto. In another embodiment, the gate driver 300 and the emission driver 600 may be disposed on the first side of the display panel 100. In an embodiment, the gate driver 300 and the emission driver 600 may be disposed on the peripheral region of the display panel 100 on the same side of the display region of the display panel 100. In an embodiment, the gate driver 300 and the emission driver 600 may be formed integrally with each other as a single chip.

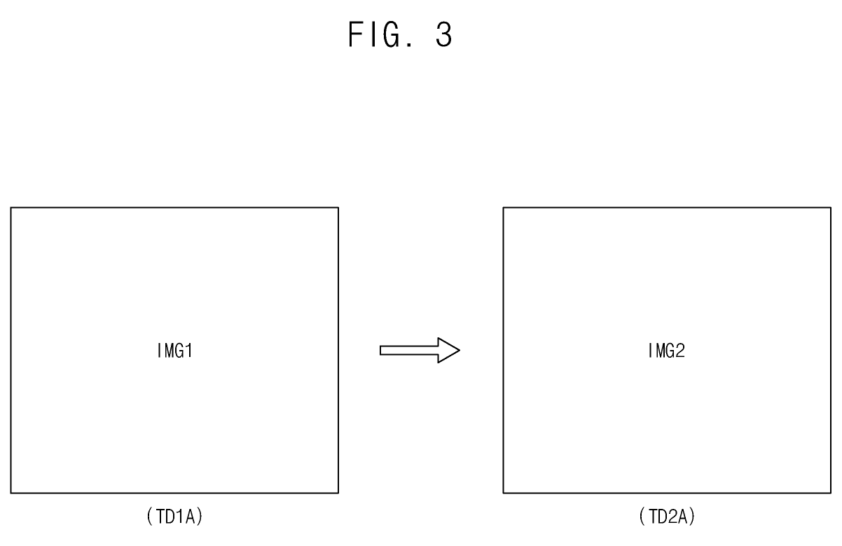

FIG. 3 is a diagram illustrating a change of an image in which a display panel 100 included in an electronic device 1 of FIG. 1 displays.

Referring to FIGS. 1-3, the display panel 100 may display a first display pattern IMG1. After displaying the first display pattern IMG1, the display panel 100 may display a second display pattern IMG2. When the display pattern displayed by the display panel 100 changes, the temperature data TD may be outputted. For example, the display panel 100 may display the first display pattern IMG1 for a first time period. After displaying the first display pattern IMG1 for the first time period, the display panel 100 may display the second display pattern IMG2. When the image displayed by the display panel 100 changes from the first display pattern IMG1 to the second display pattern IMG2, the sensor driver 30 may output the temperature data TD. For example, when the display panel 100 displays the first display pattern IMG1, the sensor driver 30 may output first temperature data TD1A. For example, when the display panel 100 displays the second display pattern IMG2, the sensing block 20 may sense the temperature of the display panel 100, and the sensor driver 30 may output second temperature data TD2A to the display panel driver 110 based on the sensed temperature. For example, the first display pattern IMG1 may be a full-white pattern, and the second display pattern IMG2 may be a full-black pattern. However, the present disclosure is not limited to the pattern of the display pattern.

When the display pattern displayed by the display panel 100 changes, the sensing block 20 may sense the temperature of the display panel 100. When the display pattern displayed by the display panel 100 changes, the sensor driver 30 may output the temperature data TD to the display panel driver 110.

In an embodiment, when the display panel 100 displays a reference display pattern, the sensing block 20 may sense the temperature of the display panel 100. When the display panel 100 displays the reference display pattern, the sensor driver 30 may output the temperature data TD to the display panel driver 110. For example, the reference display pattern may be a full-black pattern. However, the present disclosure is not limited to the pattern of the reference display pattern.

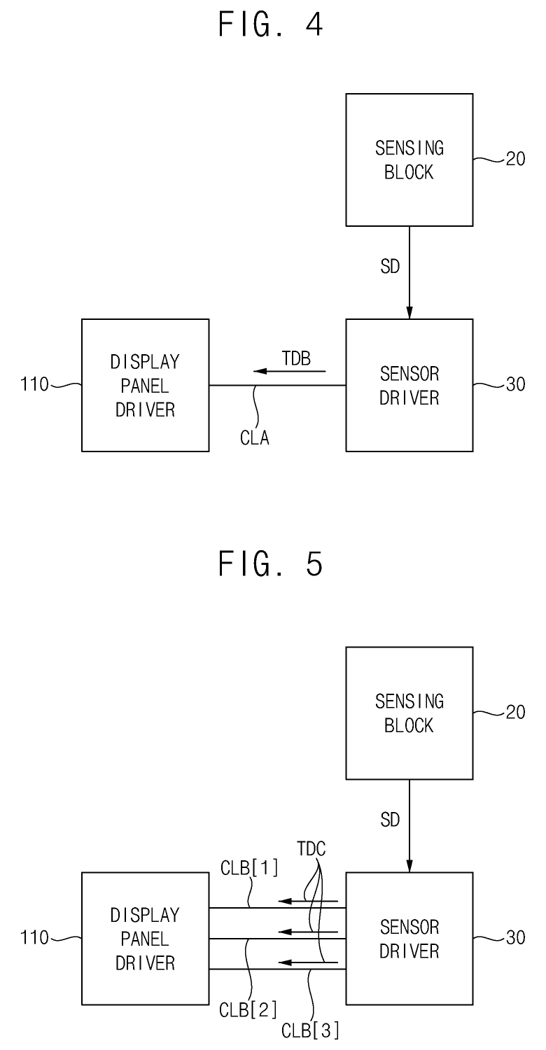

FIG. 4 is a block diagram illustrating an example of an operation of a display panel driver 110, a sensing block 20, and a sensor driver 30 included in an electronic device 1 of FIG. 1.

Referring to FIGS. 1-4, the display panel driver 110 and the sensor driver 30 may be connected through a connection line CLA. For example, the display panel driver 110 and the sensor driver 30 may be connected through a single connection line CLA.

The sensor driver 30 may receive the sensing data SD from the sensing block 20. The sensor driver 30 may output temperature data TDA to the display panel driver 110 based on the sensing data SD. The sensor driver 30 may output the temperature data TDA to the display panel driver 110 through the connection line CLA. For example, when a size of the temperature data TDA is small, the sensor driver 30 may output the temperature data TDA to the display panel driver 110 through the single connection line CLA. For example, when the temperature data TDA represents the temperature variance, the size of the temperature data TDA may be small. For example, when the temperature data TDA represents the temperature variance, the sensor driver 30 and the display panel driver 110 may be connected through the single connection line CLA.

In an embodiment, when the sensor driver 30 and the display panel driver 110 are connected through the single connection line CLA, the temperature data TDA may be serial data. In some embodiments, the temperature data TDA may be serial data generally.

In the present embodiment, the sensor driver 30 and the display panel driver 110 may be connected through the single connection line CLA. Since the sensor driver 30 and the display panel driver 110 may be connected through the single connection line CLA, an integration of the electronic device 1 may be improved.

FIG. 5 is a block diagram illustrating an example of an operation of a display panel driver 110, a sensing block 20, and a sensor driver 30 included in an electronic device 1 of FIG. 1.

Referring to FIGS. 1-5, the display panel driver 110 and the sensor driver 30 may be connected through a first connection line CLB[1], a second connection line CLB[2] and a third connection line CLB[3]. However, the present disclosure is not limited to the number of connection lines included in the electronic device 1.

The sensor driver 30 may receive the sensing data SD from the sensing block 20. The sensor driver 30 may output temperature data TDC to the display panel driver 110 based on the sensing data SD. The sensor driver 30 may output the temperature data TDC to the display panel driver 110 through the connection lines CLB[1], CLB[2] and CLB[3]. For example, when a size of the temperature data TDC is large, the sensor driver 30 may output the temperature data TDC to the display panel driver 110 through a plurality of connection lines CLB[1], CLB[2] and CLB[3]. For example, when the temperature data TDC represents the absolute value of temperature, the size of the temperature data TDC may be large. For example, when the temperature data TDC represents the absolute value of temperature, the sensor driver 30 and the display panel driver 110 may be connected through a plurality of connection lines CLB[1], CLB[2] and CLB[3]. For example, when the temperature data TDC is outputted in real time, the size of the temperature data TDC may be large. For example, when the temperature data TDC is outputted in real time, the sensor driver 30 and the display panel driver 110 may be connected through a plurality of connection lines CLB[1], CLB[2] and CLB[3].

In an embodiment, when the sensor driver 30 and the display panel driver 110 are connected through a plurality of connection lines CLB[1], CLB[2] and CLB[3], the temperature data TDC may be serial data. In an embodiment, when the sensor driver 30 and the display panel driver 110 are connected through a plurality of connection lines CLB[1], CLB[2] and CLB[3], the temperature data TDC may be parallel data.

In the present embodiment, the sensor driver 30 and the display panel driver 110 may be connected through a plurality of connection lines CLB[1], CLB[2] and CLB[3]. Since the sensor driver 30 and the display panel driver 110 may be connected through a plurality of connection lines CLB[1], CLB[2] and CLB[3], the temperature data TDC may be outputted stably. For example, when the temperature data TDC is large, the temperature data TDC may be outputted stably since the temperature data TDC may be connected through a plurality of connection lines CLB[1], CLB[2] and CLB[3].

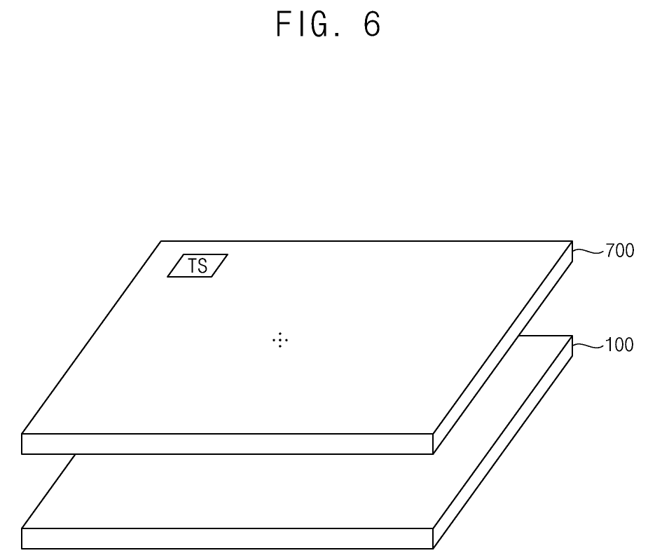

FIG. 6 is a block diagram illustrating an example of a display panel 100 and a sensing layer 700 included in an electronic device 1 of FIG. 1.

Referring to FIGS. 1 and 6, the electronic device 1 may further include a sensing layer 700. The sensing layer 700 may correspond to the sensing block 20. The sensing layer 700 may include a plurality of temperature sensors TS. In an embodiment, the sensing layer 700 may be located on the display panel 100. For example, the sensing layer 700 may be located on the upper surface of the display panel 100. In an embodiment, the sensing layer 700 may be located on the lower surface of the display panel 100.

The temperature sensors TS may sense the temperature of the display panel 100. For example, the temperature sensor TS may be a temperature sensing diode, a temperature sensing transistor, etc. However, the present disclosure is not limited to a specific type of temperature sensor. The temperature sensors TS may sense the temperature of the display panel 100 and output the temperature of the display panel 100 to the sensor driver 30. The sensor driver 30 may output the temperature data TD to the display panel driver 110 based on the sensed temperature.

In the present embodiment, the temperature of the display panel 100 may be sensed through the plurality of the temperature sensors TS. Since the temperature of the display panel 100 may be sensed through the plurality of the temperature sensors TS, an accuracy of the temperature data TD may be improved. Accordingly, an accuracy of the driving signal DS generated based on the temperature data TD may be improved. Accordingly, a display quality of the display panel 100 may be improved.

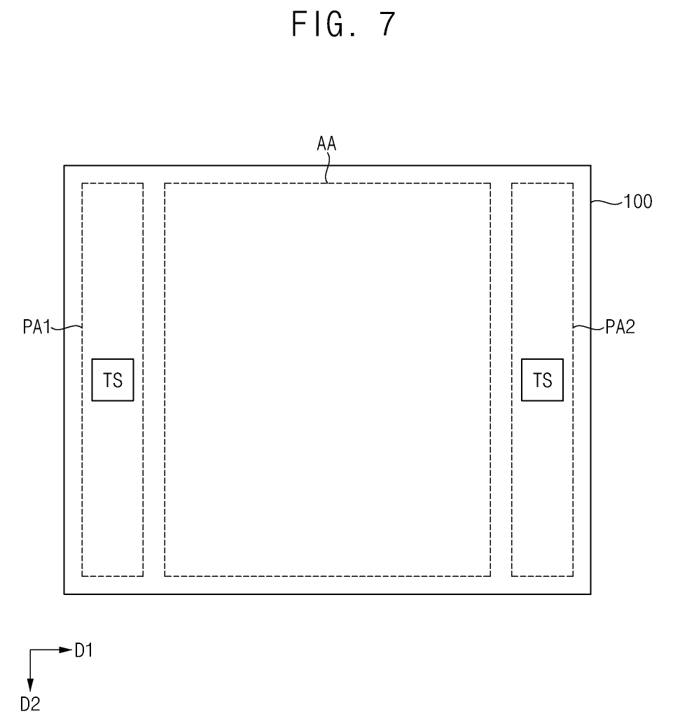

FIG. 7 is a block diagram illustrating an example of a location of a display panel 100 and a temperature sensor TS included in an electronic device 1 of FIG. 1.

Referring to FIGS. 1, 2 and 7, the display panel 100 may include a display region AA, a first peripheral region PA1, and a second peripheral region PA2. The pixel circuits PX may be located on the display region AA. The display region AA may display an image. The gate driver 300 and the emission driver 600 may be located on the first peripheral region PA1 and/or the second peripheral region PA2. The display region AA may be located spaced apart from the first peripheral region PA1 in the first direction D1. The second peripheral region PA2 may be located spaced apart from the first peripheral region PA1 in the first direction D1.

In some embodiments, the temperature sensor TS may be located on the first peripheral region PA1 and/or the second peripheral region PA2.

In some embodiments, the temperature sensor TS may be located on the first peripheral region PA1 and/or the second peripheral region PA2, so that the temperature sensor TS may sense a temperature change of the display panel 100 according to the driving of the gate driver 300. Additionally, the temperature sensor TS may be located on the first peripheral region PA1 and/or the second peripheral region PA2, so that the temperature sensor TS may sense a temperature change of the display panel 100 according to the driving of the emission driver 600. Accordingly, the accuracy of the driving signal DS generated based on the temperature data TD may be improved. Accordingly, the display quality of the display panel 100 may be improved.

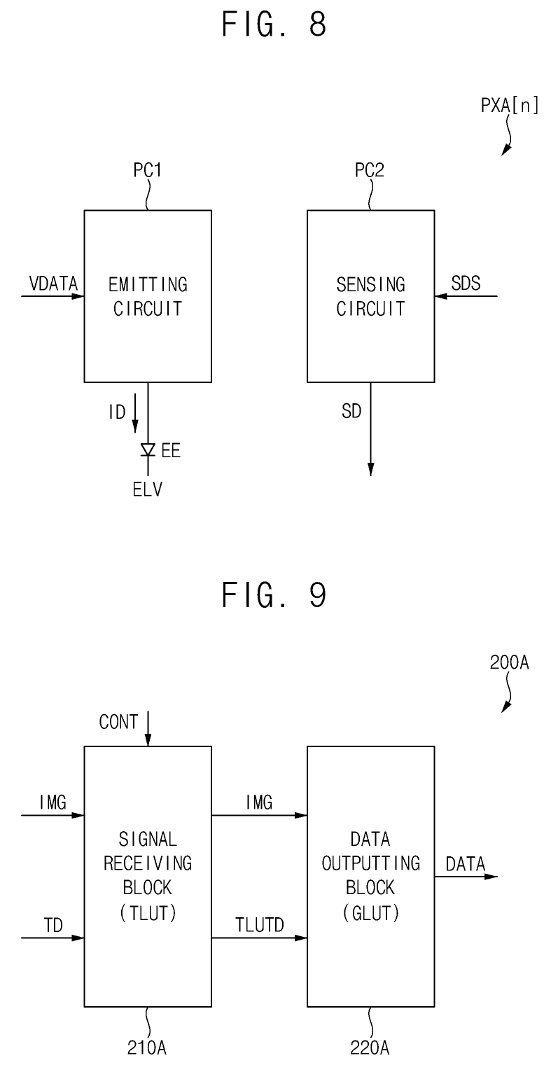

FIG. 8 is a block diagram illustrating an example of a pixel circuit PX of a display device 10 of FIG. 2.

Referring to FIGS. 1, 2, and 8, at least one pixel circuit PXA[n] of the plurality of pixel circuits PX may include an emitting circuit PC1, a sensing circuit PC2, and a light emitting element EE.

The emitting circuit PC1 may generate a driving current ID based on the data voltage VDATA. The light emitting circuit PC1 may output the driving current ID to the light emitting element EE based on the data voltage VDATA.

The sensing circuit PC2 may sense the temperature based on the sensing signal SDS. The sensing circuit PC2 may be the temperature sensor. For example, the temperature sensor may be a temperature sensing diode, a temperature sensing transistor, etc. However, the present disclosure is not limited to the type of temperature sensor. The sensing circuit PC2 may sense the temperature and output the sensing data SD . The sensing circuit PC2 may output the sensing data SD to the sensor driver 30.

The light emitting element EE may include a first electrode receiving the driving current ID and a second electrode receiving a power voltage ELV. The light emitting element EE may emit light based on the driving current ID. For example, the light emitting element EE may be a light emitting diode. In an embodiment, the light emitting element EE may be a micro light emitting diode. However, the present disclosure is not limited to the type of the light emitting element EE.

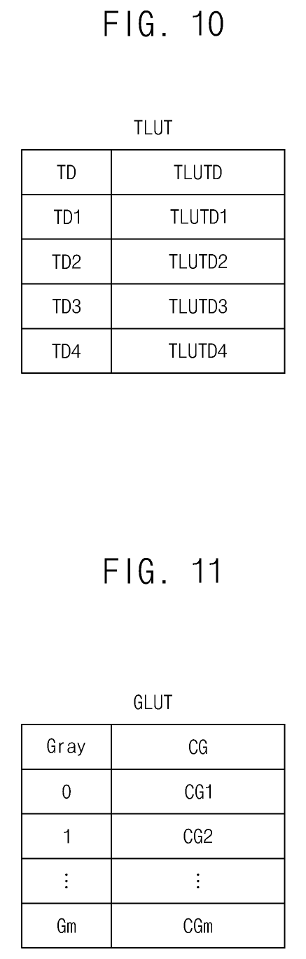

FIG. 9 is a block diagram illustrating an example of a driving controller 200 included in a display device 10 of FIG. 2. FIG. 10 is a table illustrating an example of a temperature lookup table TLUT stored in a signal receiving block 210A included in the driving controller 200A of FIG. 9. FIG. 11 is a table illustrating an example of a grayscale lookup table GLUT stored in a data outputting block 220A included in the driving controller 200A of FIG. 9.

Referring to FIGS. 1, 2, and 9-11, the driving controller 200A may include a signal receiving block 210A and a data outputting block 220A.

The signal receiving block 210A may receive the input image data IMG, the input control signal CONT, and the temperature data TD. The signal receiving block 210A may output temperature lookup data TLUTD based on the temperature data TD. The signal receiving block 210A may output the temperature lookup data TLUTD by using a temperature lookup table TLUT. The temperature lookup data TLUTD may be data for selecting a grayscale lookup table GLUT corresponding to the temperature of the display panel 100.

For example, first temperature lookup data TLUTD corresponding to first temperature data TD1 may be outputted. When the first temperature lookup data TLUTD is applied to the data outputting block 220A, the data outputting block 220A may output the data signal DATA based on the first grayscale lookup table. For example, second temperature lookup data TLUTD corresponding to second temperature data TD2 may be outputted. When the second temperature lookup data TLUTD is applied to the data outputting block 220A, the data outputting block 220A may output the data signal DATA based on the second grayscale lookup table. For example, third temperature lookup data TLUTD corresponding to third temperature data TD3 may be outputted. When the third temperature lookup data TLUTD is applied to the data outputting block 220A, the data outputting block 220A may output the data signal DATA based on the third grayscale lookup table. For example, the fourth temperature lookup data TLUTD corresponding to the fourth temperature data TD4 may be outputted. When the fourth temperature lookup data TLUTD is applied to the data outputting block 220A, the data outputting block 220A may output the data signal DATA based on the fourth grayscale lookup table.

The data outputting block 220A may receive the input image data IMG and the temperature lookup data TLUTD. The data outputting block 220A may select the grayscale lookup table GLUT based on the temperature lookup data TLUTD. The grayscale lookup table GLUT may be a lookup table for converting the grayscale of the input image data IMG. For example, when the input image data IMG displays a first grayscale, the data outputting block 220A may output a second grayscale (e.g., a converted grayscale (CG)) different from the first grayscale as the data signal DATA based on the grayscale lookup table GLUT. In an embodiment, a multi-time programming (MTP) operation for repeatedly correcting the display device 10 in terms of luminance and/or color coordinates may be performed in a manufacturing process of the display device 10. A plurality of grayscale lookup tables GLUT may be generated through multi-time programming operations. However, the present disclosure is not limited to a method for generating a plurality of grayscale lookup tables GLUT.

For example, when the input image data IMG is data corresponding to a 0 grayscale level, the data signal DATA may output the data signal DATA corresponding to a first converted grayscale CG1 which is different from the 0 grayscale level. For example, when the input image data IMG is data corresponding to a 1 grayscale level, the data signal DATA may output the data signal DATA corresponding to a second converted grayscale CG2 which is different from the 1 grayscale level. For example, when the input image data IMG is data corresponding to an m grayscale level, the data signal DATA may output the data signal DATA corresponding to an m-th converted grayscale CGM which is different from the m grayscale level. For example, the m grayscale level may be a 255 grayscale level. However, the present disclosure is not limited to the value of the grayscale level.

In the present embodiment, the sensor driver 30 may output the temperature data TD to the display panel driver 110. For example, the sensor driver 30 may directly output the temperature data TD to the display panel driver 110. Since the sensing block 20 may include a temperature sensor, an accuracy of the temperature data TD may be improved. ,

Additionally, the data signal DATA may be generated based on the temperature data TD. Accordingly, the temperature of the display panel 100 may be considered to the image displayed by the display panel 100. Since the temperature of the display panel 100 may be considered to the image displayed by the display panel 100, the display quality of the display panel 100 may be further improved.

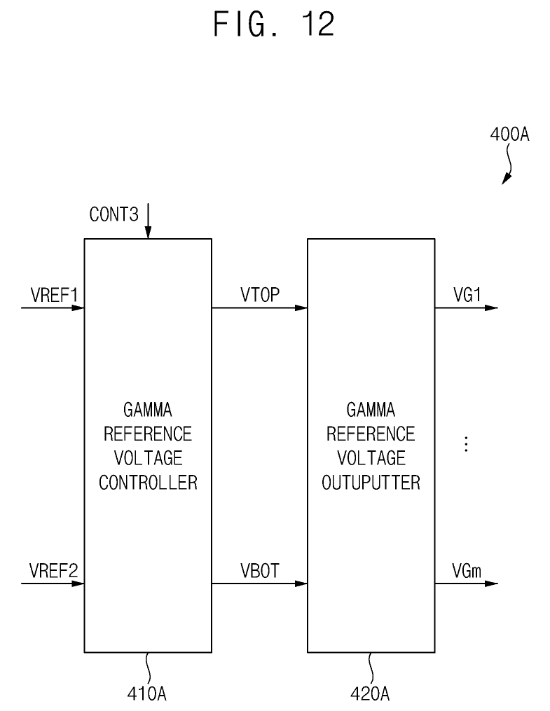

FIG. 12 is a block diagram illustrating an example of a gamma reference voltage generator 400 included in a display device 10 of FIG. 2.

Referring to FIGS. 1, 2 and 12, a gamma reference voltage generator 400A may include a gamma reference voltage controller 410A and a gamma reference voltage outputter 420A.

The gamma reference voltage controller 410A may receive a first reference voltage VREF1 and a second reference voltage VREF2 from an external device (e.g., a power manager). In an embodiment, the gamma reference voltage controller 410A may receive the first reference voltage VREF1 and the second reference voltage VREF2 from a voltage generator of the display device 10. The gamma reference voltage controller 410A may receive the first reference voltage VREF1, the second reference voltage VREF2, and the third control signal CONT3. The gamma reference voltage controller 410A may output a gamma top voltage VTOP and a gamma bottom voltage VBOT based on the first reference voltage VREF1, the second reference voltage VREF2, and the third control signal CONT3. The gamma reference voltage controller 410A may control the voltage levels of the gamma top voltage VTOP and the gamma bottom voltage VBOT based on the third control signal CONT3.

In an embodiment, the drive controller 200 may generate the third control signal CONT3 based on the temperature data TD. For example, the gamma reference voltage controller 410A may change the voltage levels of the gamma top voltage VTOP and the gamma bottom voltage VBOT based on the third control signal CONT3. The voltage levels of the gamma top voltage VTOP and the gamma bottom voltage VBOT may be changed based on the temperature of the display panel 100.

In an embodiment, the gamma reference voltage controller 410A may change the gamma bottom voltage VBOT based on the third control signal CONT3. In an embodiment, the gamma reference voltage controller 410A may change the gamma top voltage VTOP based on the third control signal CONT3.

Since the gamma bottom voltage VBOT may be changed based on the temperature data TD, a power consumption of the display device 10 may be reduced. Additionally, since the gamma bottom voltage VBOT may be changed based on the temperature data TD, the display quality of the display panel 100 may be improved. Since the gamma top voltage VTOP may be changed based on the temperature data TD, the power consumption of the display device 10 may be reduced. Additionally, since the gamma top voltage VTOP may be changed based on the temperature data TD, the display quality of the display panel 100 may be improved.

The gamma reference voltage outputter 420A may receive the gamma top voltage VTOP and the gamma bottom voltage VBOT. The gamma reference voltage outputter 420A may output first to m-th gamma reference voltages VG1 to VGm based on the gamma top voltage VTOP and the gamma bottom voltage VBOT. The first gamma reference voltage VG1 may be a gamma reference voltage corresponding to a 0 grayscale level. The m-th gamma reference voltage VGm may be a gamma reference voltage corresponding to a m number of grayscale level. In some embodiments, m-th gamma reference voltage may be the 255-th gamma reference voltage. However, the present disclosure is not limited to the number of gamma reference voltages which the gamma reference voltage outputter 420A may output. For example, the gamma reference voltage outputter 420A may output a gamma reference voltage corresponding to the 2047-th grayscale.

In the present embodiment, the data driver 500 may apply the data voltage VDATA to the display panel 100 based on the first gamma reference voltage VG1 to the m-th gamma reference voltage VGm. The first gamma reference voltage VG1 to the m-th gamma reference voltage VGm may be changed based on the temperature data TD. Accordingly, a range of the data voltage VDATA applied by the data driver 500 may be changed based on the temperature data TD.

In the present embodiment, the sensor driver 30 may output the temperature data TD to the display panel driver 110. For example, the sensor driver 30 may directly output the temperature data TD to the display panel driver 110. Since the sensing block 20 may include a temperature sensor, an accuracy of the temperature data TD may be improved. The display panel driver 110 may drive the display panel 100 based on the temperature data TD with improved accuracy.

Additionally, the range of the data voltage VDATA may be changed based on the temperature data TD. Accordingly, the temperature of the display panel 100 may be considered to the image displayed by the display panel 100. Since the temperature of the display panel 100 may be considered to the image displayed by the display panel 100, the display quality of the display panel 100 may be further improved. Since the range of the data voltage VDATA may be changed based on the temperature data TD, a power consumption of the display device 10 may be reduced. Additionally, since the range of the data voltage VDATA may be changed based on the temperature data TD, the display quality of the display panel 100 may be improved.

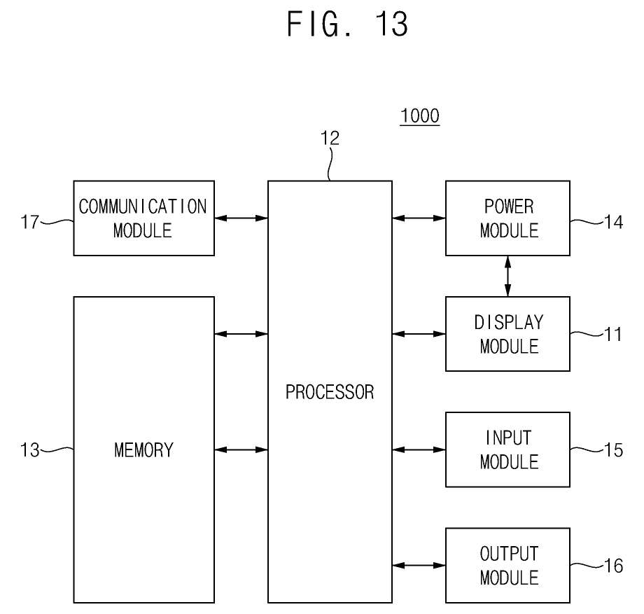

FIG. 13 is a block diagram illustrating an electronic device 1000 according to embodiments of the disclosure.

Referring to FIG. 13, an electronic device 1000 (e.g., the electronic device 1) according to an embodiment may include a display module 11, a processor 12, a memory 13, and a power module 14. In some embodiments, the electronic device 1000 may include one or more processors 12.

The processor 12 may include at least one of a central processing unit (CPU), an application processor (AP), a graphic processing unit (GPU), a communication processor (CP), an image signal processor (ISP), and a controller. The processor 12 may correspond to the device controller 40 of FIG. 1.

The memory 13 may store data information for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power required for the operation of the electronic device 1000. For example, the power module 14 may be called as a power manager.

The electronic device 1000 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 1000 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 1000 described above may be included in the display device according to the embodiments described above. Additionally, some of the individual modules functionally included in one module may be included in the display device, and other may be provided separately from the display device. For example, the display device may include the display module 11, and the processor 12, the memory 13, and the power module 14 may be provided in the form of other devices within the electronic device 1000 other than the display device.

FIGS. 14-16 are schematic diagrams illustrating an electronic device according to embodiments.

Referring to FIG. 14, a smartphone 10_1a, a tablet PC 10_1b, a laptop 10_1c, a TV 10_1d, and a desk monitor 10_1e are examples of electronic devices.

The smartphone 10_1a may include an input module such as a touch sensor and a communication module in addition to the display module 11. The smartphone 10_1a may process information received through the communication module or other input modules and display the information through the display module of the display device.

In the case of tablet PC 10_1b, laptop 10_1c, TV 10_1d, and desk monitor 10_1e, may include a display module and an input module similar to the smartphone 10_1a, and in some cases, may further include a communication module.

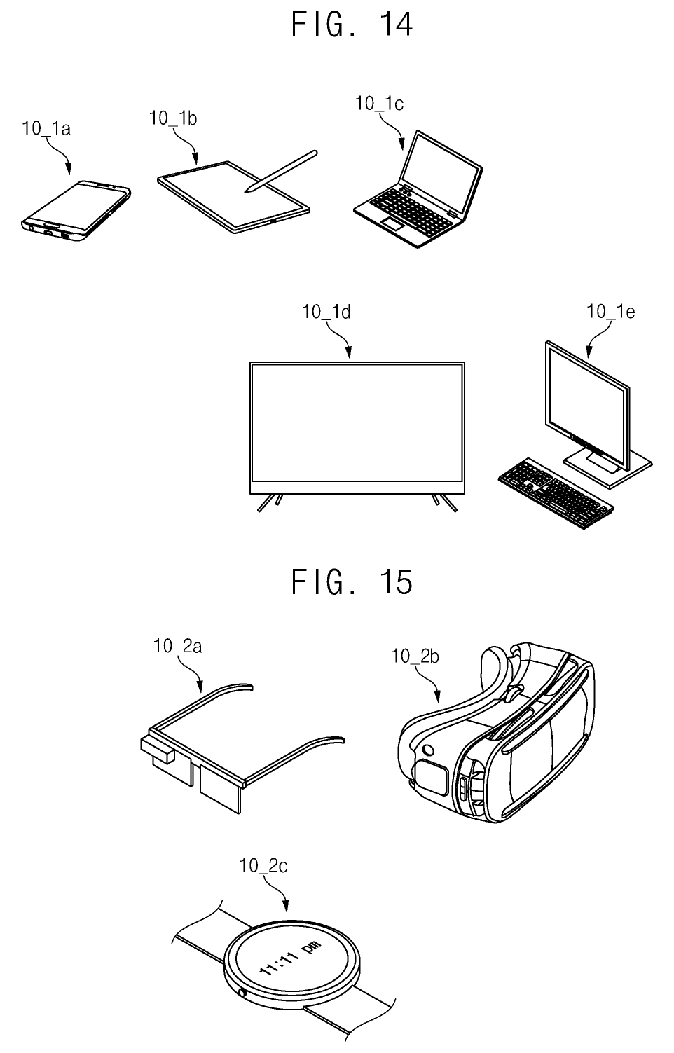

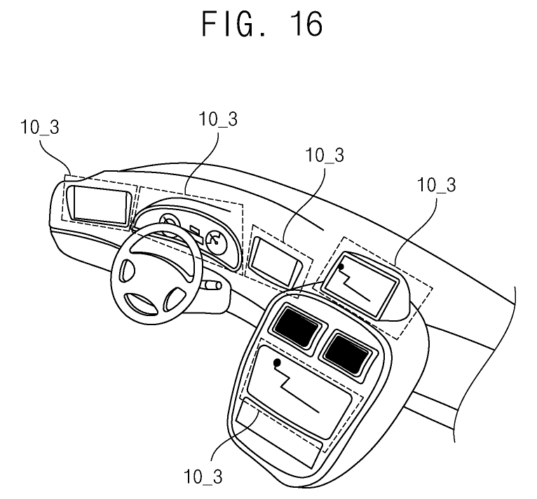

Referring to FIG. 15, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user’s eyes, thereby providing a virtual reality or augmented reality screen to the user.

The smartwatch 10_2c may include a biometric sensor as an input device and may provide biometric information recognized by the biometric sensor to the user through a display module.

Referring to FIG. 16, an electronic device including a display module may be applied to a vehicle. For example, the electronic device 10_3 may be applied to a dashboard, center fascia, etc. of a vehicle, or may be applied to a CID (Center Information Display) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a PMP, a PDA, an MP3 player, or the like.

At least one of the components, elements, modules, units, and the like (collectively "components" in this paragraph) represented by a block or an equivalent indication (collectively “block”) in the above-described embodiments including the drawings such as FIGS. 1, 2, 4, 5, 8, 9, 12 and 13 may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories including the memory 13 shown in FIG. 13 to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into one or more complex blocks.

The foregoing is illustrative of the present disclosure and is not to be construed as limiting thereof. Although a few embodiments of the disclosure concept have been described, those skilled in the art will readily appreciate that many modifications are possible in the embodiments without materially departing from the novel teachings and advantages of the disclosure concept. Accordingly, all such modifications are intended to be included within the scope of the disclosure concept as defined in the claims. In the claims, means-plus-function clauses are intended to cover the structures described herein as performing the recited function and not only structural equivalents but also equivalent structures. Therefore, it is to be understood that the foregoing is illustrative of the disclosure concept and is not to be construed as limited to the specific embodiments disclosed, and that modifications to the disclosed embodiments, as well as other embodiments, are intended to be included within the scope of the appended claims. The disclosure concept is defined by the following claims, with equivalents of the claims to be included therein.

What is claimed is:

1. An electronic device comprising:
a display panel;
a display panel driver configured to drive the display panel based on input image data and an input control signal;
one or more sensors configured to output sensing data by sensing a temperature of the display panel;
a sensor driver configured to output temperature data to the display panel driver based on the sensing data; and
a device controller configured to control the display panel driver and the sensor driver,
wherein the device controller is configured to output the input image data to the display panel driver, and
wherein the display panel driver is configured to output a driving signal to the display panel based on the temperature data, the input image data, and the input control signal.

2. The electronic device of claim 1, wherein the one or more sensors are configured to:
transmit an ultrasonic wave towards a body of a user; and
output the sensing data by receiving at least a portion of the ultrasonic wave reflected by the body,
wherein the sensor driver is configured to generate ultrasonic wave data based on the sensing data, and
wherein the sensor driver is configured to output the temperature data and the ultrasonic wave data to the device controller.

3. The electronic device of claim 1, wherein the temperature data is based on a variance of the temperature of the display panel.

4. The electronic device of claim 1, wherein the temperature data is based on an absolute value of the temperature of the display panel.

5. The electronic device of claim 1, wherein the temperature data is based on a difference value between the temperature of the display panel and a reference temperature.

6. The electronic device of claim 1, wherein the sensor driver is configured to output the temperature data to the display panel driver in real time.

7. The electronic device of claim 1, wherein the sensor driver is configured to output the temperature data to the display panel driver based on a frame period in which the display panel is driven changing from a first frame to a second frame.

8. The electronic device of claim 1, wherein the sensor driver is configured to output the temperature data to the display panel driver as a result of the display panel displaying a reference pattern.

9. The electronic device of claim 1, wherein the sensor driver is configured to output the temperature data to the display panel driver as a result of an image displayed on the display panel changing from a first display pattern to a second display pattern.

10. The electronic device of claim 1, wherein the sensor driver and the display panel driver are connected through a connection line, and
wherein the temperature data is serial data.

11. The electronic device of claim 10, wherein the temperature data is a variance of the temperature of the display panel.

12. The electronic device of claim 1, wherein the sensor driver and the display panel driver are connected through three connection lines, and
wherein the temperature data is parallel data.

13. The electronic device of claim 12, wherein the temperature data is an absolute value of the temperature of the display panel.

14. The electronic device of claim 1, wherein the display panel driver comprises:
a gate driver configured to output a gate signal to the display panel;
an emission driver configured to output an emission signal to the display panel;
a data driver configured to apply a data voltage to the display panel; and
a driving controller configured to control the gate driver, the emission driver, and the data driver based on the input image data, the input control signal, and the temperature data.

15. The electronic device of claim 14, wherein the driving controller is configured to output a data signal to the data driver based on the input image data and the temperature data,
wherein the data driver is configured to output the data voltage based on the data signal, and
wherein the display panel is configured to display an image based on the data voltage.

16. The electronic device of claim 14, wherein the driving controller is configured to output a data signal to the data driver based on the input image data,
wherein the driving controller is configured to output a data control signal to the data driver based on the temperature data, and
wherein the data driver changes a range of the data voltage based on the data control signal.

17. The electronic device of claim 14, wherein the display panel comprises a display region which displays an image,
wherein the gate driver is on a first peripheral region space apart from the display region in a first direction, and
wherein the one or more sensors are on the first peripheral region.

18. An electronic device comprising:
a display panel configured to display an image;
a display panel driver configured to drive the display panel based on input image data and an input control signal;
one or more sensors configured to sense a temperature of the display panel, and output sensing data by sensing a reflected ultrasonic wave;
a sensor driver configured to control the one or more sensors; and
a device controller configured to control the display panel driver and the sensor driver,
wherein the device controller is configured to output the input image data to the display panel driver, and
wherein the sensor driver is configured to output temperature data to the display panel driver based on the sensing data, and output the temperature data and ultrasonic wave data to the device controller.

19. The electronic device of claim 18, wherein the temperature data is a variance of the temperature of the display panel.

20. The electronic device of claim 18, wherein the temperature data is an absolute value of the temperature of the display panel.
